(19) United States
(12) Patent Application Publication
(10) Pub. No.: US 2017/0020314 A1
(43) Pub. Date: Jan. 26, 2017

(54) Educational eating plate (Edu-Plate)

(71) Applicant: Charles Brian Robinson, Los Lunas, NM (US)

(72) Inventor: Charles Brian Robinson, Los Lunas, NM (US)

(21) Appl. No.: 15/095,028

(22) Filed: Apr. 9, 2016

Related U.S. Application Data
(60) Provisional application No. 62/231,995, filed on Jul. 23, 2015.

(51) Int. Cl. A47G 19/02; A47G 19/03; G09B 3/00; G09B 19/00; G09B 15/00

(52) U.S. Cl. CPC A47G 19/025; G09B 19/0046; G09B 19/0061; G09B 15/00; G09B 3/00; A47G 19/03

(57) ABSTRACT

This product, Edu-Plate, is a paper (or plastic) disposable plate on which a child will eat his/her meal.

It will have a stimulating, and/or historical, or a topical question on the top side, and the answer to the question will be fun, and informative, and will appear on the bottom of the plate.

Edu-Plate is an innovative product geared toward children who are interested in learning interesting new (to them) ideas and facts designed to inspire them, and to open up their imaginations to new concepts to help expand their learning horizons.

### TITLE OF THE INVENTION

Educational Eating Plate (Edu-plate). A food plate with a question on one side and an answer on the backside—an educational tool used as a learning devise as-well-as a food plate.

This concept could assist school age children with exploring new ideas, learning proven techniques, looking at career opportunities, and stretching their imaginations. The answers to the questions are: informative, interesting, and accurate.

### FIELD OF INVENTION

Education.

### BRIEF SUMMARY OF THE INVENTION

My new product, Edu-Plate, does more than “teach”—it also displays the goal of opening up the possibilities of future career paths for our nation's children. The primary value though is to open up their imaginations to what might be possible for them in their future. My products artwork gives the child the experience of seeing the full, immediate, concrete reality of his or her distant career and lifestyle goals. A given individual may choose to move forward, to translate the meaning of that experience of seeing the artwork into the actual course of his or her own life. The artwork, on the plates, serves yet another purpose: It becomes a beacon of sorts raised over the crossroads of the world, saying—“This is possible.”

### BRIEF SUMMARY OF VIEWS OF THE DRAWINGS

See attached sheet.

### DETAILED DESCRIPTION OF THE INVENTION

Size of the educational plates and composition (elements): Standard-sized disposable plates of approximately 8.75″, and 7″, in diameter (and other popular sizes) will be used. Composition of the plates will be paper, or plastic, or other suitable materials normally made by plate (disposable) manufacturers.

Printing process: The plates will be printed on both sides, some in black and white, and some in color variations.

Printing and packaging will be done as a manufacturing process.

### DRAWINGS:

A total of twelve (12) sheets of drawings are enclosed with this Utility Application.

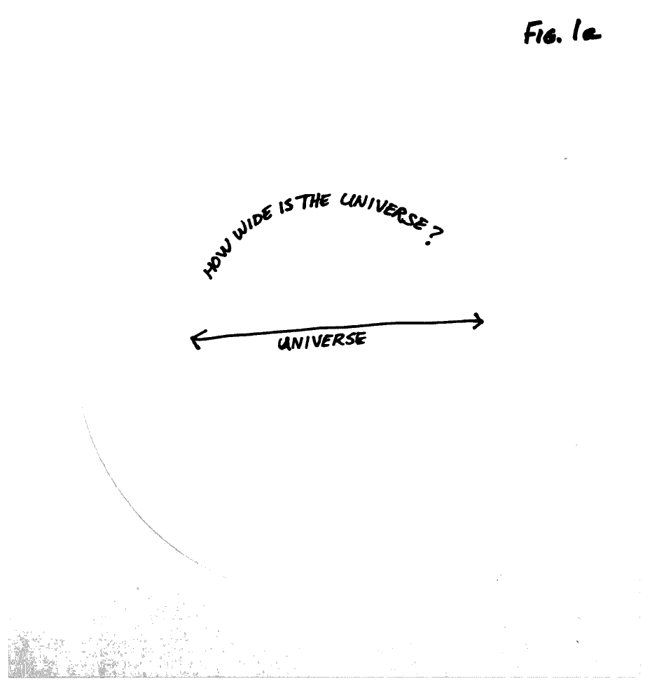

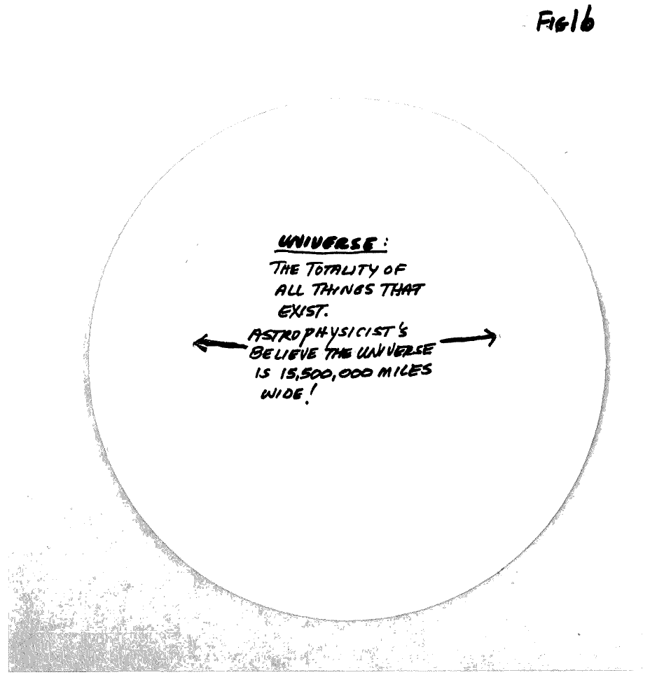

FIG. 1a—is a front perspective view of a plate showing one of my new educational food plates asking a question of the person using it, in this case, “How wide is the Universe?” It is illustrated.

FIG. 1b—is a rear-view perspective, thereof, with the answer to the question on the opposite (bottom) side.

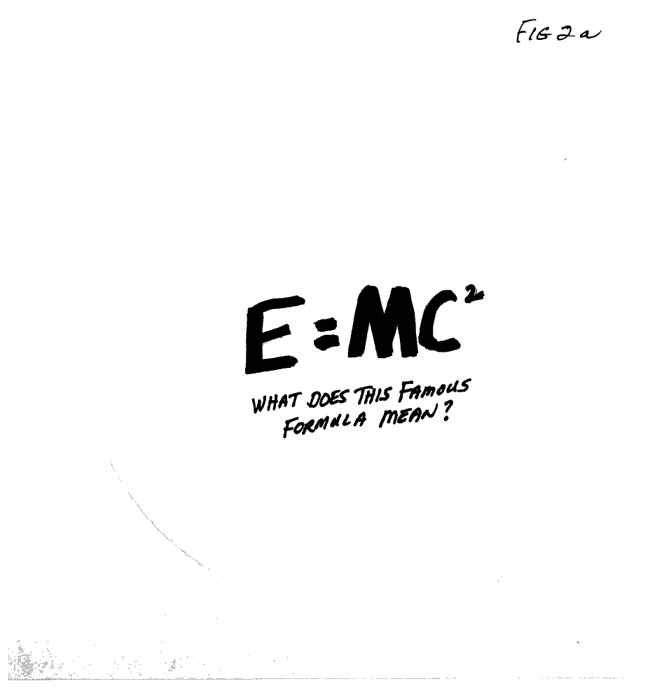

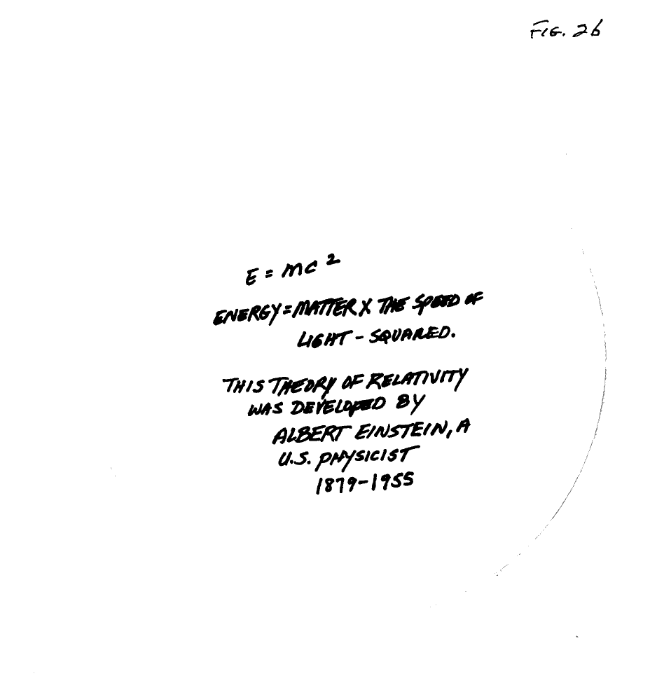

FIG. 2a—is a depiction of Aristotle, Socrates, and Plato on the front side of a prototype food plate, with the question: “Who were these men?”

FIG. 2b—rear view of the FIG. 2a plate, with the answers.

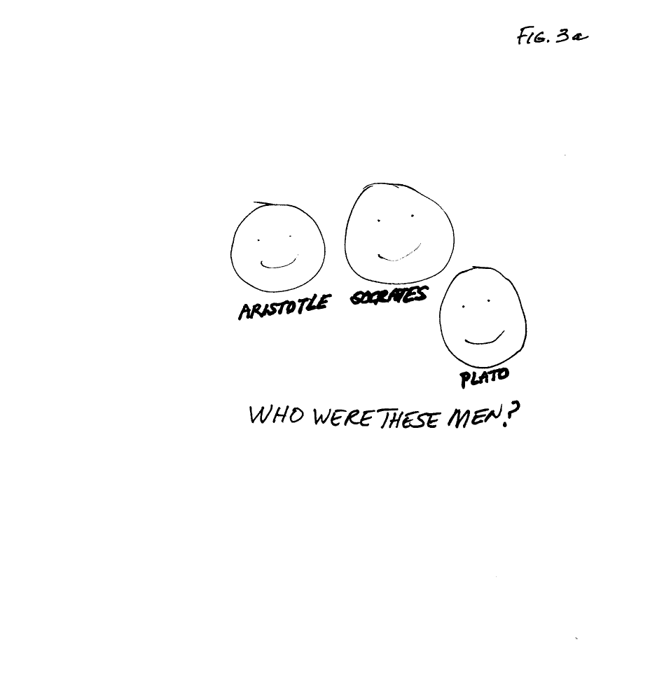

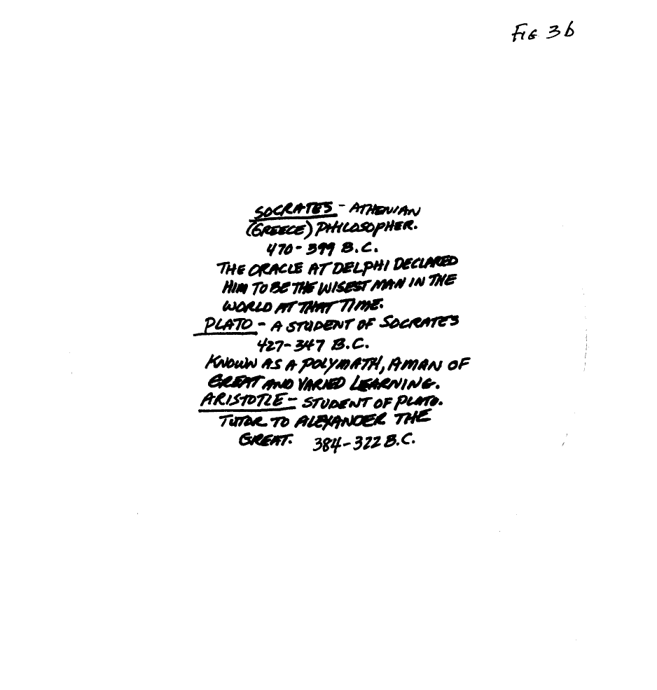

FIG. 3a—is the depiction of the equation, E=mc2 (squared), asking the question, “What does this famous formula mean?”—on the front side of the plate.

FIG. 3b—is the answer, on the backside, to the question on the front side of the plate in FIG. 3a.

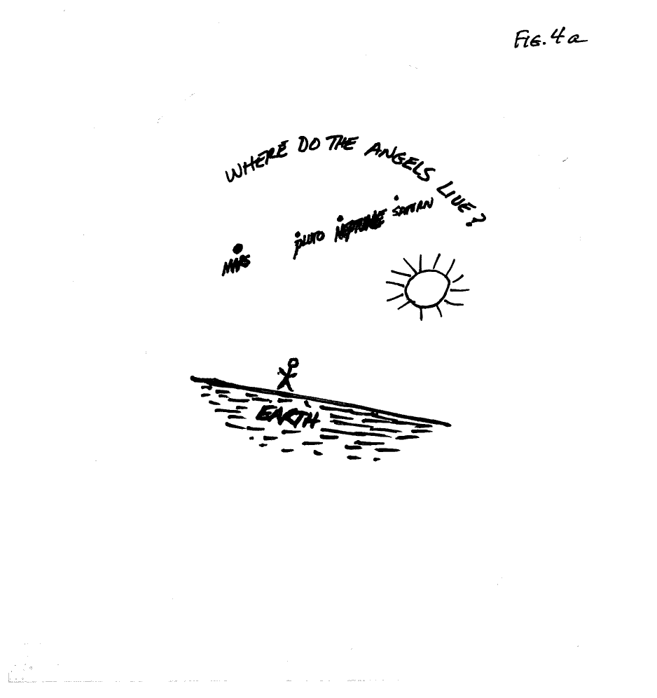

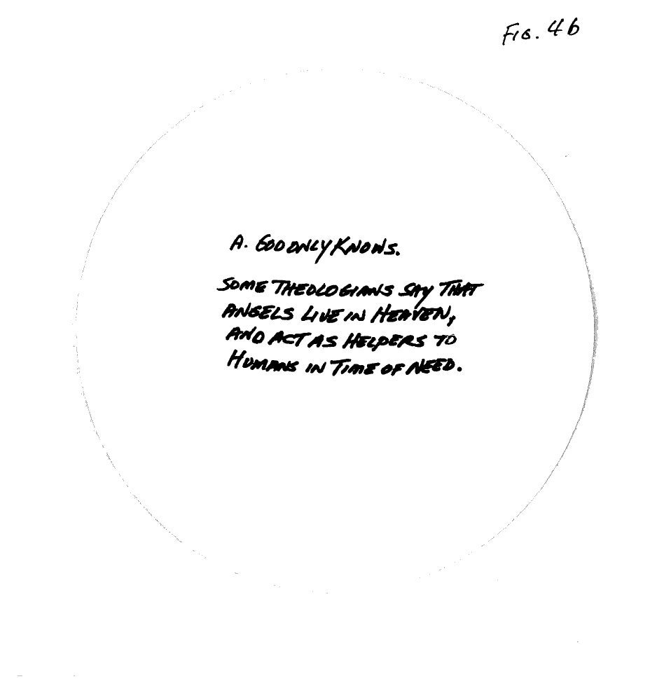

FIG. 4a—Illustrates, and asks the question, “Where do the angels live?”—on the front side.

FIG. 4b—Answers the above question, “Where do the angels live?” on the back side.

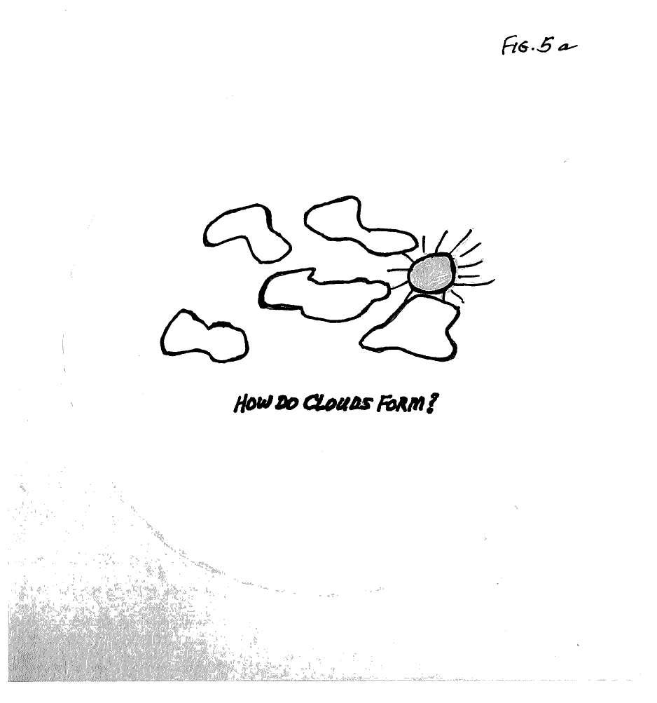

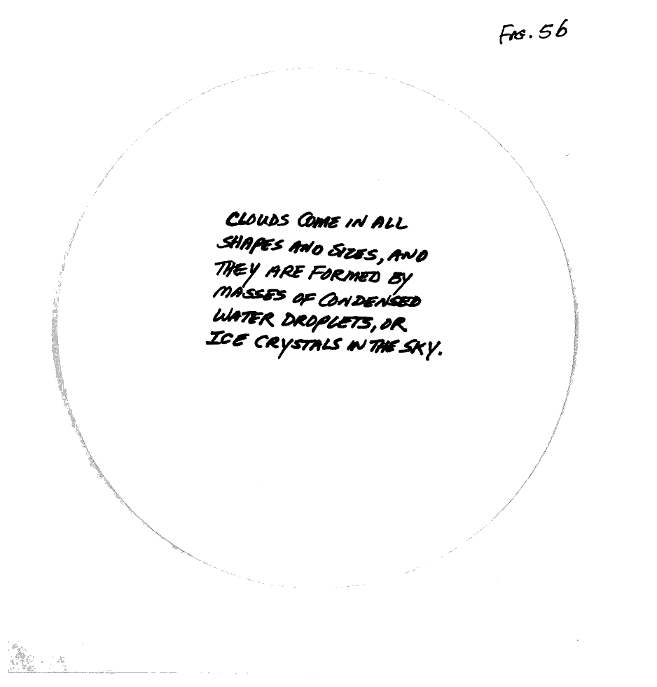

FIG. 5a—This plate asks the question, “How do clouds form?” on the front side, along with an illustration.

FIG. 5b—The answer to the above question is on the back of the plate.

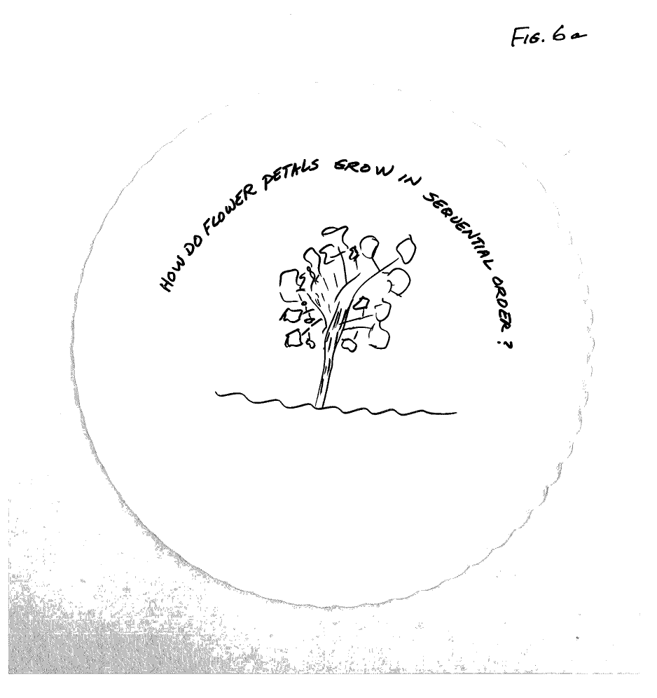

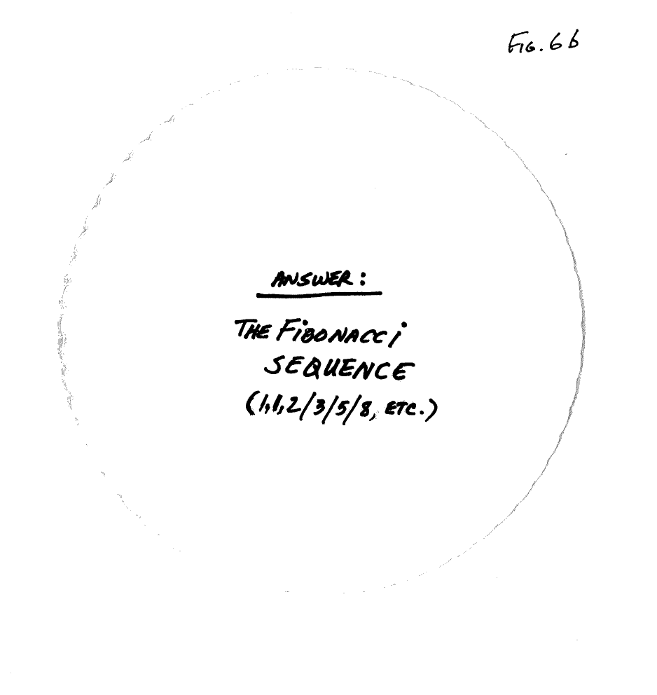

FIG. 6a—This prototype plate illustrates the growth of a flowering plant, and asks the question, “How do flower petals grow in sequential order?” (Front view).

FIG. 6b—Rear view of the above plate (FIG. 6a), with the correct answer, ie. Fibonacci Sequence.

These drawings are submitted to assist the examiner to conceptualize what this invention will look like, and how it will be used by the public. These are just a few examples of what this invention is. I have hundreds of other plates already created, and more that are in the planning stages.

1. An educational eating plate (Edu-Plate): a disposable (paper or plastic) food plate with a question printed on one side and an answer on the back side; it is an educational tool used as a learning device as-well-as a food plate.

2. An educational disposable food plate featuring: sports legends, historical facts, science, travel, famous people, musical themes, nature, and licensed characters, using the format described above in claim 1.
